(19) United States
(12) Patent Application Publication
(10) Pub. No.: US 2025/0199339 A1
(43) Pub. Date: Jun. 19, 2025

(54) ELECTRONIC EYEGLASSES

(71) Applicant: LUXOTTICA S.R.L., Agordo (IT)

(72) Inventors: Dino MICHELON, Ponte Nelle Alpi (IT); Gianluca CANDIOTTO, Castello Di Godego (IT)

(21) Appl. No.: 18/836,273

(22) PCT Filed: Jan. 25, 2023
(86) PCT No.: PCT/EP2023/051790

§ 371 Date: Aug. 6, 2024

(30) Foreign Application Priority Data
Feb. 9, 2022 (IT) 102022000002315

(51) Int. Cl. G02C 11/00; G02C 5/14; G02C 5/22

(52) U.S. Cl. CPC G02C 11/10; G02C 5/14; G02C 5/22

(57) ABSTRACT

Electronic eyeglasses having a front and a pair of temples respectively connected to the front by hinges and further including a flexible cable adapted to be incorporated within the front, in order to carry data signals and/or power to the temples, the flexible cable extending at least to nose pads and/or to at least one rim region of the front, the flexible cable forming at least one active region at the nose pads and/or the rim which is adapted to act as a capacitive sensor in order to detect gestures on the part of the user.

### CROSS-REFERENCE TO RELATED APPLICATIONS

This application is a 35 U.S.C. § 371 National Stage patent application of PCT/EP2023/051790 filed 25 Jan. 2023, which claims the benefit of Italian patent application 102022000002315 filed 9 Feb. 2022, the disclosures of which are incorporated herein by reference in their entirety.

### TECHNICAL FIELD

The present disclosure relates to electronic eyeglasses. More particularly, the disclosure relates to electronic eyeglasses which integrate electronic components and sensors.

### BACKGROUND

As is known, electronic eyeglasses are becoming increasingly widespread on the market, and each manufacturer has the goal firstly of optimizing the efficiency of the electronics in the eyeglasses, and therefore of optimizing their power consumption in order to increase battery life, even for high performance of the eyeglasses, and secondly of making the electronic eyeglasses as similar as possible to eyeglasses of the “normal” type, thus preventing the electronic components and the sensors from having an excessive impact on the aesthetics of said eyeglasses. This is true for both the lens part and the frame part. It is therefore necessary to adopt an aesthetics that hides the cables, the sensors and all the electronics contained in the eyeglasses, so that it is not only inaccessible by the user but also concealed and perfectly integrated with the aesthetics of the object.

Furthermore, in particular the electronic eyeglasses must be able to have one or more devices adapted to detect a voluntary action on the part of the user in order to implement functions of the electronic eyeglasses or sensors that detect the will of the user and appropriately implement these functions. Therefore, it is possible to have one or more from the manual switch (for example, buttons) or sensors (for example, light sensors, motion sensors, capacitive touch sensors, ambient sensors, inertial sensors, etc.).

Electronic eyeglasses are known in the background art in which the flexible cable runs in a specially created duct along the entire front between the right lens and the left lens in order to mutually connect the temples.

This flexible cable is then concealed by means of a covering system, which on the one hand is functional but on the other hand is aesthetically unsatisfactory.

Technical solutions are also known in which there is a capacitive sensor of the “swift touch” type, but this sensor is not totally integrated within the flexible cable but rather is generically arranged within the device (for example in the temples).

### SUMMARY

The aim of the present disclosure is to provide electronic eyeglasses in which the flexible cable passing through the front allows to increase the flexibility of the system from the electronic/software standpoint and also allows to integrate the sensor capable of detecting the gestures made by the user.

Within this aim, the present disclosure provides electronic eyeglasses in which the flexible cable is concealed as much as possible in the front of the eyeglasses, thus without compromising their aesthetics and/or functionalities.

The present disclosure also provides electronic eyeglasses that are capable of detecting when they are worn by a user.

Not least of the present disclosure is to provide electronic eyeglasses that are highly reliable, relatively easy to provide and at competitive costs.

This aim and these and other advantages that will become better apparent hereinafter are achieved by providing electronic eyeglasses, comprising a front with respective nose pads, a pair of temples respectively connected to the front by means of hinges, and further comprising a flexible cable adapted to be incorporated within said front in order to carry data signals and/or power to said temples, characterized in that the flexible cable is extended at least to the nose pads and/or to the rim region of said front, said flexible cable forming at least one active region at said nose pads and/or said rim which is adapted to act as a capacitive sensor in order to detect gestures on the part of the user.

In particular, the flexible cable is incorporated within the front and the nose pads by means of an overmolding process, adhesive bonding or other methods known in the background art.

### BRIEF DESCRIPTION OF THE DRAWINGS

Further characteristics and advantages of the disclosure will become better apparent from the description of preferred but not exclusive embodiments of the eyeglasses according to the disclosure, illustrated by way of non-limiting example in the accompanying drawings, wherein:

FIG. 1 is an exploded front perspective view of a first embodiment of the eyeglasses according to the present disclosure;

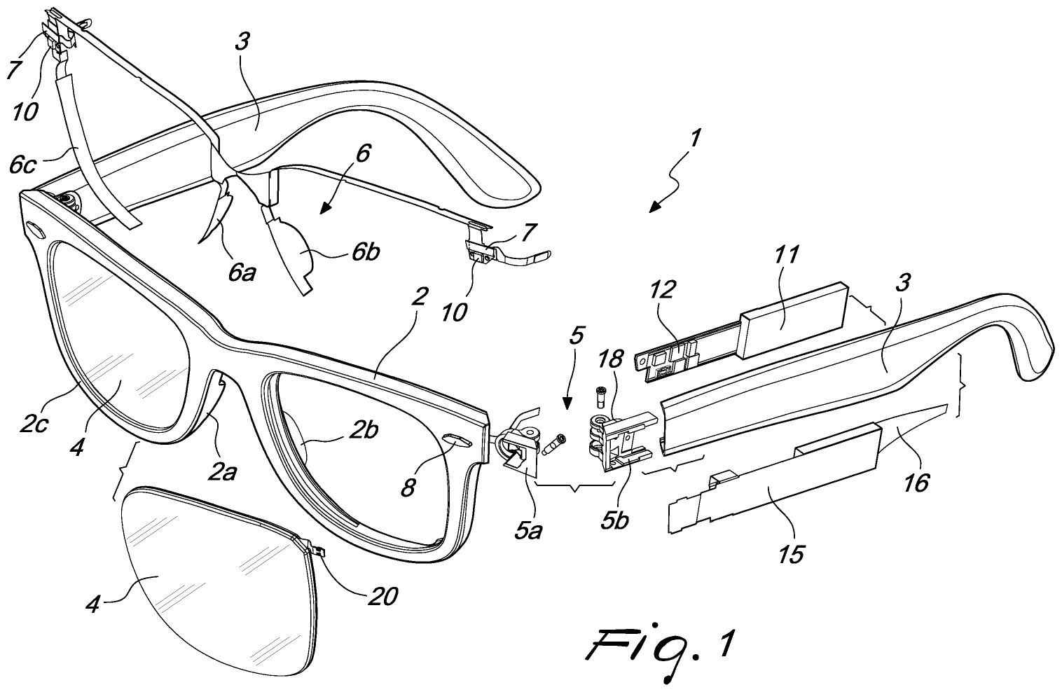

FIG. 2 is a longitudinal sectional view of a detail of the region of the hinge of the eyeglasses according to the disclosure shown in FIG. 1;

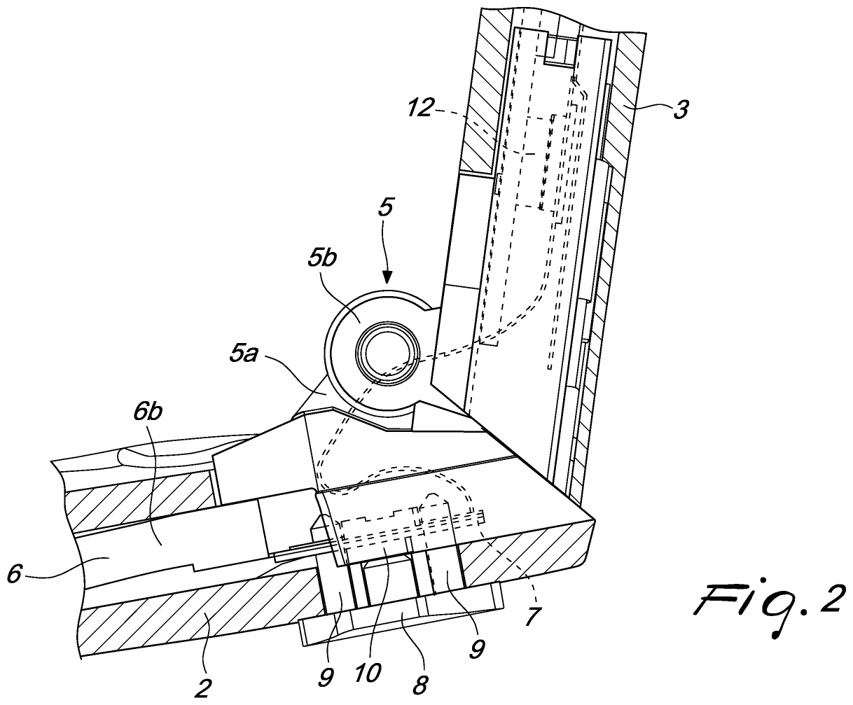

FIG. 3 is a perspective view of the eyeglasses according to the disclosure, shown in FIGS. 1 and 2, in an assembled condition;

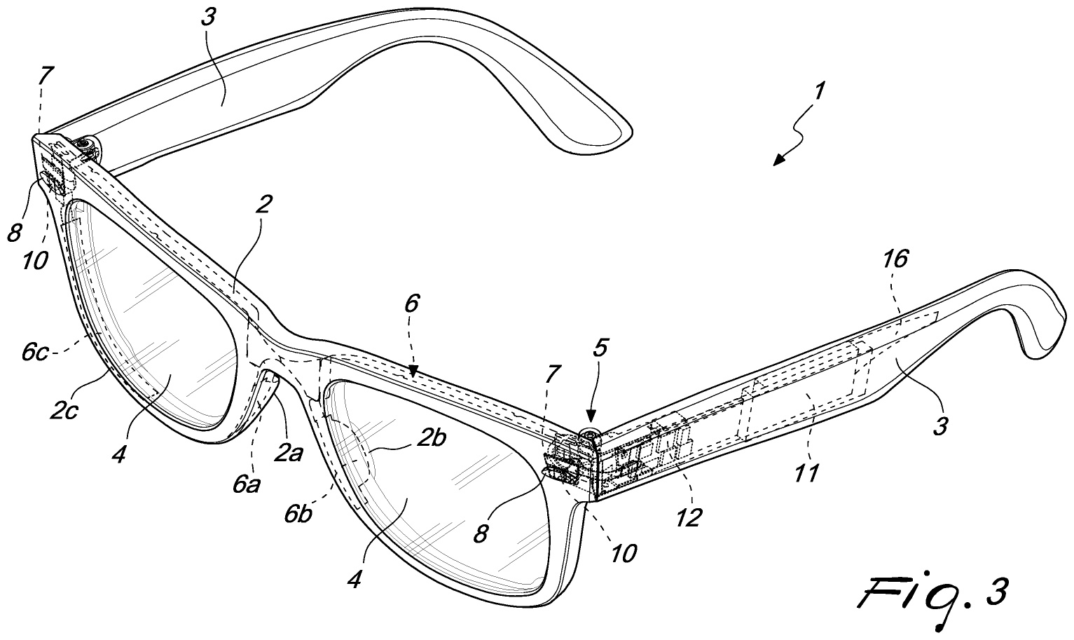

FIG. 4 is an exploded front perspective view of a second embodiment of the eyeglasses according to the present disclosure; and

FIG. 5 is a perspective view of the eyeglasses according to the disclosure, shown in FIG. 4, in an assembled condition.

### DETAILED DESCRIPTION OF THE DRAWINGS

With reference to the figures, the electronic eyeglasses according to the disclosure, generally designated by the reference numeral 1, comprise a front 2 adapted to be coupled to a pair of temples 3 by means of a pair of respective hinges 5. A pair of lenses 4 completes the eyeglasses 1.

Conveniently, the front 2 incorporates an overmolded and/or glued flexible cable 6, which is adapted to mutually connect the temples 3 with a signal/data link but also a power supply in order to charge a battery that is accommodated within the temple 3.

Conveniently, the flexible cable 6 is arranged within the upper region of the front and is extended at least to the nose pads 2a, 2b and/or to the rim region 2c of the front, i.e., the region of the front that has a curvature almost at right angles. In particular, the flexible cable 6 is extended to the region comprised between the endpiece of the eyeglasses, i.e., the part for connection between the front and the temple, up to the nose pads.

In an alternative embodiment, the flexible cable 6 is monolithic from the endpiece to the nose pads without any connection to the central part of the cable.

The flexible cable 6 forms at least one active region 6a, 6b at the nose pads 2a, 2b and/or at least one active region 6c at the rim 2c of the front 2, which is adapted to act as a capacitive sensor in order to detect gestures on the part of the user.

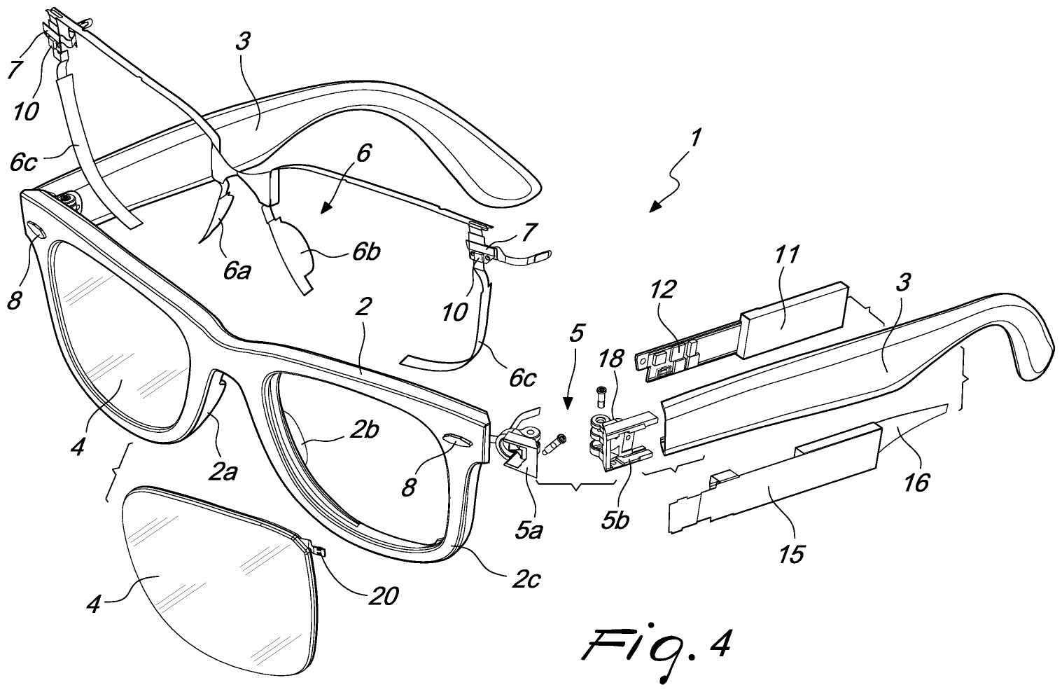

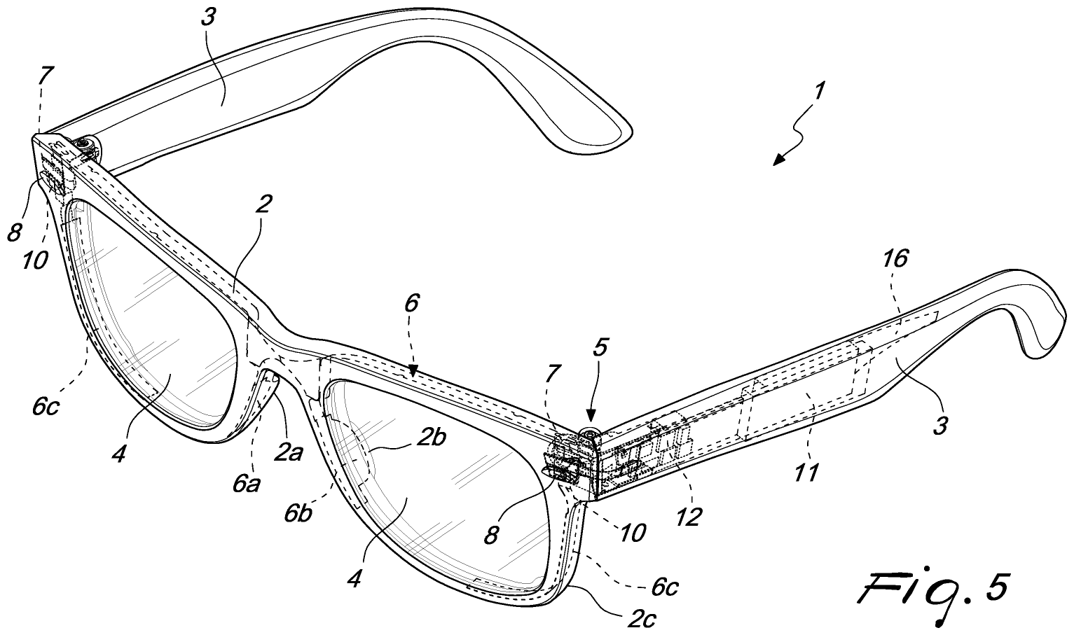

In an embodiment shown in FIGS. 4 and 5, the flexible cable 6 is extended at both rim regions of the front.

As an alternative, the capacitive sensor can be replaced and/or integrated with an accelerometer and/or other electronic device. Generally, the region of the flexible cable 6 at the nose pads and/or at the rim is therefore dedicated to a device capable of detecting the gestures of the user, be it a capacitive sensor, an accelerometer and/or other electronics. Said gestures allow, for example, to darken or lightening the lenses according to the user's preferences.

The capacitive sensor 6a, 6b and/or 6c can be adapted furthermore to perform other functions such as: switching the eyeglasses on and off, detecting wearability on the part of the user and in general capturing any input by the user, by way of non-limiting example, control of the audio functionalities, photograph taking, requesting information to be displayed on the device, activating voice control, etc.

Essentially, the flexible cable 6 has active regions 6a, 6b, and/or 6c which are touch sensitive and are adapted to be used as a capacitive sensor. With this implementation, the flexible cable 6 has regions 6a, 6b and/or 6b that are slightly wider at the nose pads 2a, 2b and/or at the rim 2c than the remaining central portion of the cable 6, so as to have the broadest possible active region, so as to increase the sensitivity and the ability to detect the voluntary touch reactions in the active regions.

The flexible cable 6 is overmolded at a rear region of the front 2 and is provided at the respective ends with plates 7, which are adapted to be coupled to a locking element 8, provided at the front 2 of the eyeglasses and formed by a substantially elliptical element which is provided internally with locking pins 9.

Conveniently, the locking pins 9 are coupled at fixing holes formed in the plates 7.

Advantageously, the locking device 8 is made of a material adapted to diffuse light so as to collect ambient light and diffuse it onto an ambient light sensor 10 provided at the plates 7.

As an alternative, the flexible cable 6 is glued at the two ends by means of specific adhesives for gluing electronic components which are known in the background art.

Conveniently, the temple 3, at its part that is the outermost but still accommodated within the body of the temple 3, may have a further capacitive sensor 15 which allows to detect the gestures of the user, like the active regions 6a, 6b, 6c of the flexible cable 6.

Furthermore, a further capacitive sensor 16 may be present which allows to detect whether the eyeglasses are being worn or not by the user.

The active regions 6a, 6b and/or 6b and the region that corresponds to the capacitive sensor 15 allow to detect user gestures and/or any input by the user.

The user can perform single or multiple touches or taps, or slide his fingers on the sensitive region 6a, 6b and/or 6b, which are detected as sudden impulses with a specific force and for a specific time.

Conveniently, the sensor 16 that detects whether the eyeglasses are being worn, can be—as mentioned—a capacitive sensor, or it is possible to use inertial units with 3/6 axes (accelerometer, accelerometer plus gyroscope) or also an adherence sensor located in the nose pads of the eyeglasses (not shown in the figures).

The eyeglasses according to the disclosure may furthermore comprise a capacitive sensor of the touch type, which can be arranged in the front portion of the temple 3, proximate to the hinge 5. The capacitive sensor of the touch type may be replaced by an inertial unit with 3/6 axes (accelerometer, accelerometer plus gyroscope) also arranged in the front part of the temple 3. The user can perform single or multiple touches or taps, or slide his fingers on the temple 3, which are detected as sudden impulses and with a specific force.

Furthermore, the hinge 5 is divided into a hinge component 5a that is coupled directly to the front 2 and a hinge component 5b that is coupled to the temple 3. The hinge allows the passage of the flexible cable from the temples to the front.

A LED emitter 18 is arranged at the region of the hinge component 5a (or 5b) that is directed toward the user when the eyeglasses are being worn and provides a luminous notification indication to the user, related, for example, to the level of the battery, or other information.

Other sensors and/or emitters, such as, by way of non-limiting example, temperature sensors, pressure sensors or, more generically ambient sensors may also be arranged at the region of the hinge component 5a or 5b and provide a notification indication to the user via the LED emitter 18 or via an adapted app.

The active regions 6a, 6b and/or 6c, as well as the capacitive sensor 15, allow to control the degree of safety of the lenses and all the functionalities described above, for example by means of the downward sliding movement of the hand from above or vice versa for the active region 6c at the rim 2c of the front 2 and at the capacitive sensor 15.

Moreover, the electronic eyeglasses according to the disclosure may comprise a reset sensor. In this case, at least for one of the temples 3, a printed circuit board 11 is provided inside it and supports the electronics, which comprises a Hall sensor 12 which allows to detect the presence of magnetic fields (strength and direction). This component allows to define thresholds for the intensity of the magnetic field and its directionality beyond which the sensor is activated.

When the reset sensor is activated, it is possible to have the electronic eyeglasses perform various operations that are programmed into the firmware. For example, one of these operations is a system reset.

It is also possible to provide a Hall sensor adapted to trigger for example switching on/off functions or others.

The reset sensor 12 is conveniently integrated within the temple 3 without having to have an access toward the outside environment, thus preserving the aesthetics of the temple and the integrity of the sensor.

In practice it has been found that the electronic eyeglasses according to the disclosure fully achieve the intended aim and advantages, since they allow to accommodate a flexible cable, overmolded by injection, which is adapted to both supply power to the battery of the eyeglasses and to carry the data signals from one temple to the other.

Furthermore, the flexible cable forms active regions which act as capacitive sensors in order to detect gestures on the part of the user, which are capable of modifying, for example, the safety degree of the lenses as a consequence of a simple hand movement performed by the user.

The eyeglasses thus conceived are susceptible of numerous modifications and variations, all of which are within the scope of the accompanying claims.

All the details may furthermore be replaced with other technically equivalent elements.

In practice, the materials used, as well as the contingent shapes and dimensions, may be any according to the requirements and the state of the art.

1-5. (canceled)

16. Electronic eyeglasses, comprising a front with nose pads and a pair of temples respectively connected to the front by means of hinges and further comprising a flexible cable configured to be incorporated within said front, in order to carry data signals and/or power to said temples, wherein said flexible cable is extended at least to said nose pads and/or to at least one rim region of said front, said flexible cable forming at least one active region at said nose pads and/or said rim which is adapted to act as a capacitive sensor in order to detect gestures on the part of a user.

17. The electronic eyeglasses according to claim 16, wherein said capacitive sensor is integrated within said flexible cable.

18. The electronic eyeglasses according to claim 16, wherein said flexible cable has, at ends thereof, a pair of plates adapted to support at least one ambient light sensor.

19. The electronic eyeglasses according to claim 16, further comprising a locking element adapted to be inserted in holes formed in the front, in order to couple at a rearward region of the front with said plates.

20. The electronic eyeglasses according to claim 19, wherein said locking element is made of a material adapted to diffuse light so as to collect ambient light and diffuse it on an ambient light sensor provided at said plates.

21. The electronic eyeglasses according to claim 18, wherein said flexible cable which is extended at least to the nose pads and/or at least to the rim region of said front is monolithic and bonded with adhesive at the ends.

22. The electronic eyeglasses according to claim 16, further comprising an additional capacitive sensor adapted to be inserted in at least one of said temples in order to detect gestures on the part of the user.

23. The electronic eyeglasses according to claim 16, further comprising at least one additional sensor, which is accommodated within at least one of said temples and is adapted to detect whether said eyeglasses are being worn or not by said user.

24. The electronic eyeglasses according to claim 23, wherein said at least one additional sensor accommodated within at least one of said temples in order to detect whether said eyeglasses are being worn or not by said user is of the capacitive or inertial or ambient type.

25. The electronic eyeglasses according to claim 23, wherein said at least one additional sensor adapted to detect whether said eyeglasses are being worn or not by said user is an adherence sensor arranged in the nose pads of said eyeglasses.

26. The electronic eyeglasses according to claim 16, wherein said hinge comprises, in an internal position, adapted to be directed toward said user, at least one LED (18) in order to provide feedback to said user.

27. The electronic eyeglasses according to claim 26, wherein said hinge comprises additional sensors adapted to measure data useful for the user and to be visualized by means of said LED.

28. The electronic eyeglasses according to claim 16, wherein said flexible cable is overmolded by injection within said front, in a rearward position so as to be directed toward said user, integrated within said front.

29. The electronic eyeglasses according to claim 16, further comprising a reset sensor integrated within at least one of said temples.

30. The electronic eyeglasses according to claim 29, wherein said reset sensor comprises a Hall sensor adapted to detect presence of magnetic fields.
